(19) United States
(12) Patent Application Publication
(10) Pub. No.: US 2018/0101144 A1
(43) Pub. Date: Apr. 12, 2018

(54) METHOD FOR THE UTILIZATION OF DATA FROM A PLURALITY OF MACHINES

(71) Applicant: SICK AG, Waldkirch/Breisgau (DE)

(72) Inventors: Bernhard FÜGER, Offenburg (DE); Fabian SCHMIDT, Teningen (DE); Christian RAPP, Hamburg (DE)

(21) Appl. No.: 15/726,738

(22) Filed: Oct. 6, 2017

(30) Foreign Application Priority Data
Oct. 10, 2016 (EP) 16193051.6

(51) Int. Cl. G05B 11/01; G06F 17/30; G06F 11/34; G06F 11/30; B41M 3/00

(52) U.S. Cl. CPC G05B 11/01; G06F 17/30569; G01N 21/95; G06F 11/3013; B41M 3/00; G06F 11/3409

(57) ABSTRACT

The invention relates to a method for the utilization of data from a plurality of machines, in which
operating data from a plurality of machines are detected by a plurality of sensors, wherein the operating data have different first data formats, with the respective first data format depending on the respective sensor;
the operating data are converted by at least one abstraction module into abstraction data, wherein the abstraction data have a uniform second data format and are stored in a central memory device;
an analysis of the abstraction data is carried out, wherein the analysis is based on operating data from at least two machines;
an operating state of one of the machines is assessed with reference to the analysis; and
the analysis of the abstraction data is output.

The present invention relates to a method for the utilization of data from a plurality of machines, in which operating data from a plurality of machines are detected by a plurality of sensors, wherein the operating data have different first data formats, with the respective first data format depending on the respective sensor.

In today's production processes, comprehensive data that, for example, relate to parameters of different machines are detected in an automated manner. These data are e.g. used for controlling the respective machine.

A further-going utilization of the detected data is, in contrast, not carried out. In conventional production processes, a plurality of detected data are therefore only utilized in part or not at all even though these data are present and include information or knowledge on the production processes.

It is therefore the underlying object of the invention to provide a method that enables an improved utilization of data recorded in processes such as production processes.

This object is satisfied in accordance with the invention by a method in accordance with claim 1.

The method in accordance with the invention serves for the utilization of data from a plurality of machines, in which
operating data from a plurality of machines are detected by a plurality of sensors, wherein the operating data have different first data formats, with the respective first data format depending on the respective sensor;
the operating data are converted by at least one abstraction module into abstraction data, wherein the abstraction data have a uniform second data format and are stored in a central or decentralized memory device;
an analysis of the abstraction data is carried out, wherein the analysis is based on operating data from at least two machines;
an operating state of one of the machines is assessed with reference to the analysis; and
the analysis of the abstraction data is output.

The method provides the possibility of creating additional synergistic effects that enable an improvement of production processes. Due to the “characterization of the data” in the second data format, said data can be managed in a substantially more flexible manner by a machine. The degree of automation can thereby be greatly increased with a comparatively small demand in effort and cost.

The method in accordance with the invention is based on the core idea that by evaluating a plurality of machines, conclusions can be drawn on one of the evaluated machines and/or on another machine, i.e. a further machine. It can, for example, be recognized by such an analysis that a specific error occurs regularly in a specific type of machine under specific external conditions. The error can then be avoided for a further machine of this type.

It is a further core idea of the invention that a uniform second data format which is, for example, enriched by semantics—as stated in the following—is provided by the abstraction module and enables a central or decentralized evaluation of the abstraction data. In other words, the abstraction data are stored in the second data format such that the abstraction data are independent of the format of the operating data. This means that different operating data, i.e. operating data in different first data formats, are converted or supplemented into the same abstraction data provided that the operating data have the same contents. Measurement data, i.e. the operating data that were converted into abstraction data by the abstraction module, therefore indirectly serve as a basis for the analysis.

The second data format thus provides the possibility of monitoring, evaluating, analyzing and integrating a plurality of sensors, machines and processes and of storing the abstraction data produced hereby in a central or decentralized manner and in a uniform data format such that central or decentralized services, such as a central or decentralized evaluation, become possible. In addition, an increasingly comprehensive database is accumulated over time which enables increasingly improved analyses.

The invention is therefore based on the recognition that a technical added value can be provided by the second data format for the abstraction data since the second data format is suitable for an evaluation and analysis related to a plurality of machines. Such an analysis based solely on different first data formats would have been nearly impossible to be carried out or only with a very large demand in effort and cost.

The use of the abstraction data having the uniform second data format additionally has the advantage that the abstraction data can be accessed in a simple manner by any desired processes, machines or services.

In the analysis, abstraction data are used by at least two machines, products, processes and/or sensors. An operating state of one machine is assessed with reference to the analysis, wherein this one machine can be one of the at least two machines that serve as a basis for the analysis. Alternatively, the machine whose operating state is assessed can also be a further (third) machine.

The analysis can, for example, be represented graphically with the aid of graphs, diagrams and the like on the output of the analysis. The analysis can, for example, be a live analysis or a long-term analysis. In the live analysis, the instantaneously generated abstraction data are analyzed and an analysis based thereon is output. In a long-term analysis, data that go back further, for example all of the data stored in the central memory device, are also supplied to the analysis.

A machine is preferably to be understood as an individually controllable unit in a production process, for example a drill, a cutter, a saw, a conveyor belt, a printer, a soldering system, a laser marking device and the like. The sensor that observes the respective machine can also be integrated into the respective machine and can, for example, indicate an internal temperature or an engine speed.

By way of example, the invention can be used in a production process using a plurality of consecutive machines. The machines can e.g. carry out production processes that follow one another in a production line. A first machine can, for example, introduce bores into a component or into a workpiece, whereupon a second machine cuts threads into the bores of the component and a third machine screws respective screws into the thread produced. If errors now occur on the boring or on the cutting of the threads, errors can thus also occur on the screwing in of the screws. Conversely, errors that occur frequently on the screwing in of the screws or on the cutting of the threads can also indicate inaccuracies or errors on the boring. Such errors can be recognized and assessed much better by the analysis in accordance with the invention of at least two machines than if a respective machine is considered separately. An early recognition of errors that occur (later) can in particular also be carried out as will be explained in the following.

In the above-mentioned example, the results of the thread cutting and of the screwing in of the screws could, for example, be analyzed. If it is recognized that both the process of the thread cutting and the process of the screwing in of the screws take place free of error, but a high proportion of defective components is nevertheless present after the screwing in of the screws, it can be concluded that the boring e.g. takes place too imprecisely. In this case, the operating state of the first machine (drill) is therefore assessed with reference to the analysis of the abstraction data of the second and third machines and it is recognized that the boring is in need of improvement.

It could furthermore be recognized in an exemplary manner that the boring and the thread cutting take place without problem, but that a specific proportion of waste is nevertheless produced. It is hereby possible to conclude on the basis of the evaluation of a plurality of machines that errors occur on the screwing in of the screws. The third machine can then be examined with respect to its operability.

It is also possible to detect operating data from machines from a plurality of parallel production lines or assembly lines. The operating data of the different production lines can hereby be stored in the abstraction data. The different production lines can at least partly have the same machines. In this way, the operating data of a production line can contribute to the improvement of the production in another production line.

The detected operating data of the respective machine can e.g. be data from the machine itself or data of the process carried out by the machine and/or data that relate to the workpiece processed by the machine. By way of example, the data of the machine itself can indicate a location or an identification number of the machine. The data of the process carried out by the machine can e.g. indicate a rotational speed, a temperature or a pressure that is generated by the machine.

The data that relate to the workpiece can e.g. comprise the position and/or the offset of a borehole.

The operating data can be collected and stored by a central server. The operating data can e.g. be transmitted via the protocols TCP (transmission control protocol), UDP (user datagram protocol), HTTP (hypertext transfer protocol) and/or MQTT (message queue telemetry transport) or by means of the web socket protocol. Alternatively or additionally, the operating data can also be transmitted via a serial interface (e.g. EIA-232 or EI-A485).

Advantageous further developments of the invention are described in the description, in the drawing and in the dependent claims.

In accordance with a first advantageous embodiment of the invention, the analysis is used to control, in particular automatically control, at least one of the machines. This means that a feedback to the machine takes place, whereby the machine can be regulated. The analysis therefore contributes to changing the behavior or the control of one of the machines. A fully automatic setting, e.g. of parameters, can in particular take place. An automatic improvement of the production can hereby be achieved.

The feedback to the machine can e.g. take place by means of HTTP, MQTT, via a serial interface and/or by means of web sockets.

The analysis is preferably used in order to achieve an optimization, in particular an automatic optimization, of the operation of at least one of the machines. As already stated above in an exemplary manner, problems of individual machines can be recognized by the analysis of errors in a production process. The operation of the machine recognized as an error source can hereby then be changed in order to improve or optimize the operation of this machine. For this purpose, an ideal or optimized operating setting can be derived from the set of abstraction data. Settings which are, for example, used by other machines of the same type that work free of error can preferably be determined from the abstraction data. The optimization can preferably also take place in the context of the other machines, i.e. the setting of a machine can take place in dependence on preceding or following machines in order to utilize synergistic effects with the setting. The utilization of the synergistic effects is particularly simple through the abstraction data since the abstraction data can be read by any desired processes on the basis of their data format. Furthermore, new machines, processes and/or sensors of the same type can be inserted seamlessly into the system environment, for example in the design of a further assembly line. The integration demand in effort and cost can therefore be greatly reduced.

In accordance with a further advantageous embodiment, the machines are involved in a common production process. This means that a first machine, for example, carries out a first production step, a second machine carries out a second production step and a third machine carries out a third production step. Alternatively, the machines can also carry out production steps together, i.e. two or more machines can be involved in a single production step.

In accordance with a further advantageous embodiment, the first data format is a data format that is used natively by the respective sensor. This means that the first data format is used or output as standard by the respective sensor and is, for example, predefined by the respective manufacturer of the sensor.

In order to convert the respective first data format of a sensor into the abstraction data, the respective abstraction module is preferably configured to convert the first data format into the abstraction data. The abstraction module can comprise information on the structure of the first data format for this purpose. A respective separate abstraction module can in particular be provided for each first data format.

The second data format can, for example, be generated from the first data format in that supplements and/or additions are made to the operating data (in the first data format). The supplements can take place in the form of the semantics explained in the following.

The abstraction module can be integrated in a (software) container. By way of example, each abstraction module can be a separate application that is isolated in a container by means of an operating system virtualization. The open source software Docker can e.g. be used for such an operating system virtualization.

Due to the integration of the abstraction module into a container, the abstraction module can be used across platforms and can provide the abstraction data for a respective first data format independently of an operating system.

In accordance with another embodiment, the first data format respectively differs for at least some of the sensors. Different first data formats can therefore be provided by different sensors.

The second data format preferably comprises semantics that provides the abstraction data with meanings and associates said abstraction data with at least one category. The semantics allows the association of meanings and/or categories with the abstraction data, i.e. with the converted operating data. The use of semantics allows a simplification of a use of the abstraction data from a plurality of machines. In addition, it is made possible to store a plurality of different machines and thus of different data in the abstraction data since it can be recognized what the data states by means of the association of the meaning and/or of the category. By way of example, a pressure, a temperature, a rotational speed and the like can be provided as categories. In order to implement the semantics, the abstraction data can be stored in a database and/or in a markup language such as XML (extensible markup language).

The abstraction data are preferably divided into categories for different data classes and/or different individual or linked process steps. The abstraction data for different assembly lines can also be divided into different categories. Environmental data, order data, quality data, inspection data, process data, machine data and/or product data can, for example, be provided as categories for the data classes. The categories can at least partly intersect or overlap other categories. Data can also be simultaneously associated with a plurality of categories. This means that e.g. machine data can be present for each process step and/or for each assembly line.

Categories for specific measured values (e.g. errors or tolerance values) can e.g. also be allocated by the semantics. It is hereby possible that the abstraction data are always designed in the same manner independently of the sensor used or of the machine used or of the processor used and can be understood by the semantics independently of which process carries out the analysis. The analysis can be carried out centrally, i.e. on the named server. The server can comprise the central memory device, wherein the server is, for example, configured as a cloud server. Alternatively, the analysis can also be carried out locally by the respective machine (or by the respective sensor) or by a process of a data processing system associated with the respective machine.

In accordance with a further advantageous embodiment, the abstraction module automatically provides the operating data with the semantics; i.e. the abstraction module carries out an automatic annotation of the operating data. It is hereby made possible that new, i.e. previously unknown, sensors or unknown first data formats can also be automatically processed by the abstraction module, i.e. without a manual adaptation of the abstraction module. The automated annotation can be satisfied by means of machine learning. The annotation system (i.e. the abstraction module) learns more and becomes successively more precise as the data increase.

For this purpose, the abstraction module can, for example, draw conclusions on the structure of the first data format of the initially unknown sensor using the data of said sensor with reference to known value ranges that result from the abstraction data for a parameter measured by the sensor.

New and unknown sensors can then advantageously be seamlessly integrated into the production process and can immediately be used for the provision of abstraction data. The more data are known to the abstraction module with respect to the (production) environment and infrastructure, the faster and better an automatic assignment can take place.

By way of example, it is possible with a temperature sensor, which monitors a soldering process, to search directly for values in the range from 200 to 350° C. in the first data format of this sensor. If such values can be recognized by the abstraction module at a specific point of the first data format, the abstraction module can thus provide these values with the corresponding semantics and store them in the abstraction data or convert them into the abstraction data. In order to be able to carry out more complex learning processes, the abstraction module can comprise an artificial intelligence or a fuzzy logic. Alternatively or additionally, the semantics can also be added manually at least in part.

The second data format particularly preferably comprises relationships between the categories of the abstraction data. The second data format or the abstraction data can thus represent a relational database and/or implement a so-called entity-relationship model. By way of example, a relationship between a material of a component and a rotational speed required for it on the boring through the component can be indicated in the abstraction data.

The relationships between the categories of the abstraction data can preferably be taught such that the abstraction data can e.g. also additionally indicate that the increase of a value in a category typically has the consequence of a specific effect. An increased power consumption in a boring process can, for example, indicate that an earlier cutting process was imprecise and that the drill now abuts a remaining edge.

In accordance with a further advantageous embodiment, the analysis is output on a display device, preferably a portable display device, that displays a position of the machine to which the analysis is related. A worker can, for example in large and confusing production halls, be guided in a simple manner directly to the corresponding machine by the display of the position of the corresponding machine. The information is preferably filtered intelligently and only displayed to the responsible and/or correspondingly qualified worker in a context-based manner. Once the worker has arrived at the machine, the machine can be set or can be monitored more precisely. The portable display device can in particular be a cellular telephone or a tablet computer. The portable display device can, for example, be connected to the central memory device by means of a radio connection (e.g. WLAN). On site, a sensor can then display supplementary, more precise data via its display.

The analysis preferably includes an indicator field of the respective machine. The indicator field can, for example, comprise measured values, i.e. operating data, of the last few hours or days such that it can be seen from the indicator field whether errors occur in the respective machine or not. A changed setting of the machine can thus be carried out with reference to the indicator field. The indicator field in particular comprises diagrams having a box plot such that a scattering of measured values is indicated. The indicator field can in particular also include a comparison with identical or similar machines. The indicator field can be output on the portable display device such that the indicator field is available “on site” and can simplify the setting of a machine.

The analysis output can preferably also include a traffic-light code. This means that the operating state of the respective machine is e.g. indicated by the colors green (proper operation), yellow (warning or minor errors) and/or red (failure, massive error). The operating state of a machine can be pointed out to the operator in a fast and reliable manner by the traffic-light code.

The analysis can further preferably include a histogram. The histogram can e.g. indicate an error frequency of one of the machines in different time periods.

The analysis can further preferably represent further types of diagrams such as bar charts and/or measurement progressions in time including tolerance ranges, etc.

In accordance with a further advantageous embodiment, at least one of the abstraction modules is integrated in the respective sensor. This means that the sensor can directly output and/or accept abstraction data. The abstraction modules can generally also be arranged centrally, for example in the server, or can be executed by the server.

The abstraction modules can communicate with one another and can in this manner also learn from the respective specialized abstraction module in order e.g. to integrate new components faster.

The use of sensors having an integrated abstraction module can greatly simplify the integration of new sensors into an existing production process since no change of abstraction modules is necessary. The respective manufacturer of the sensor can instead provide the corresponding abstraction module.

In accordance with a further embodiment, the analysis is output to a production control system and/or to an operation control system. The analysis can therefore e.g. be output to an enterprise resource planning system (ERP) or e.g. to a manufacturing execution system (MES). A resource planning and/or a sequence planning can be carried out on the basis of the analysis. By way of example, a resource planning can be changed to the extent that fewer components are produced when it is recognized that the waste of a production process is reduced.

In accordance with a further advantageous embodiment, the analysis is supplied to an instruction module, wherein the instruction module changes the operation of one of the machines. The instruction module can generate specific instructions for the operation of the respective machine from the abstraction data and/or from the analysis. The instruction module can for this purpose be arranged in the respective machine or it can also be arranged centrally in the named server. The instruction module can, for example, derive from the analysis that there is an offset for a borehole such that the next borehole is corrected by the offset.

The analysis particularly preferably includes a prediction about a future operating state of one of the machines. By way of example, the prediction can be based on abstraction data from similar or identical other machines, wherein it is e.g. determined that a failure of the machine has taken place after a respective specific number of operating hours. It can hereby then be predicted that a further machine of this type will also fail with a high probability after a specific number of operating hours. The prediction profits greatly from the abstraction data and is e.g. generated by an artificial intelligence or by a fuzzy logic. The prediction is preferably based on the abstraction data.

In accordance with a further advantageous embodiment, operating data from a paste printer that applies soldering paste and from a soldering system are detected by means of optical sensors in accordance with the method. In accordance with this embodiment, the analysis comprises the quality of a paste print and the quality of a soldering process. A change in the operation of the soldering system is preferably carried out on the basis of the quality of the paste print and/or a change in the operation of the paste printer is carried out on the basis of the quality of the soldering process.

For example, data are therefore converted into abstraction data by two separate abstraction modules via the paste printer and the soldering system. The abstraction data can subsequently be analyzed.

If it is, for example, determined in the analysis that an offset is produced on the application of soldering paste during the paste printing, it can thus be assumed that an increased waste is produced in the soldering process. In this respect, a change in the operation of the soldering system can then be carried out such that the soldered parts are monitored using a higher number of samples. Conversely, the operation of the paste printer can be changed on the determination of problems in the soldering process such that e.g. an offset of the paste printer is compensated. The quality of the soldering process can hereby then be increased.

A further subject of the invention is a system that comprises at least two machines; at least two sensors; and a processing device. The system in accordance with the invention is configured to carry out a method of the above-explained kind. The processing device can be formed by a server that can also comprise the central memory device. The sensors and the machines are preferably coupled to the processing device by means of data connections.

In accordance with a preferred embodiment of the system, at least one of the sensors is integrated into one of the machines and/or is a component of the respective machine. The operating data can therefore originate from the respective machine itself and can, for example, indicate an internal temperature, a rotational speed and the like. The operating data can be provided, e.g. in a digital manner, by a control computer of the respective machine. Alternatively, the respective sensor can also, as already mentioned, be separate.

The statements made on the method in accordance with the invention apply accordingly to the system in accordance with the invention, in particular with respect to advantages and preferred embodiments.

The invention will be described in the following purely by way of example with reference to the drawing. It is shown:

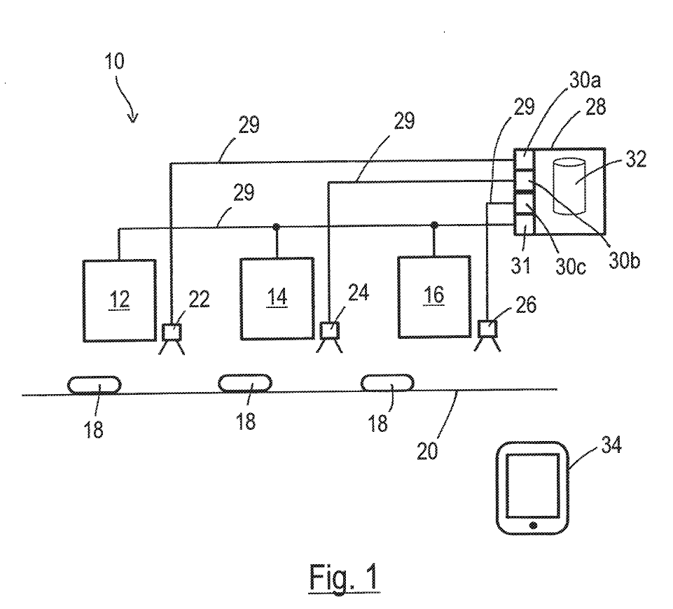

FIG. 1 a production process in a schematic view, in which a method for the utilization of data from a plurality of machines is used.

FIG. 1 shows a production line 10 in which a paste printer 12 is arranged as the first machine, an assembler 14 as the second machine, and a soldering system 16 as the third machine.

Components 18 to be processed that e.g. comprise circuit boards are first printed with soldering paste by the paste printer 12. The components 18 are subsequently supplied by a conveyor belt 20 to the assembler 14 that places electric and electronic components onto the components 18. Finally, the components 18 are transported by the conveyor belt 20 to the soldering system 16 that melts the soldering paste under the effect of heat, wherein fixed electrically conductive connections with the electronic components are produced on the subsequent solidification of the soldering paste.

The function of the paste printer is monitored by a first optical sensor 22 that determines an offset of the soldering paste, for example.

The placement by the assembler 14 is monitored by a second optical sensor 24 and finally the soldering result of the soldering system 16 is monitored by a third optical sensor 26.

The optical sensors 22, 24, 26 are coupled to a server 28 by means of data lines 29, wherein three abstraction modules 30a, 30b, 30c are integrated into the server 28 and are executed by the server 28.

Operating data of the respective machine 12, 14, 16 is transmitted in a respective different first data format from the optical sensors 22, 24, 26 to the abstraction modules 30a, 30b, 30c by means of the data lines 29. The abstraction modules 30 convert the respective first data format into abstraction data in a uniform second data format. The abstraction data are stored in a central memory device 32.

The sensors 22, 24, 26 can alternatively also be integrated into the respective machine 12, 14, 16 such that the machines 12, 14, 16 can also be coupled directly to the respective abstraction module 30a, 30b, 30c by means of data lines (not shown).

An analysis of the production process and thus an analysis of the three machines 12, 14, 16 are carried out by the server 28 on the basis of the abstraction data in the central memory device 32. If it is, for example, recognized that the soldering system 16 produces too many defective components 18, a setting of the paste printer 12 can thus be changed in order to apply more or less soldering paste onto the components 18, for example. In order to change the setting of the paste printer 12, the paste printer 12 is controlled by the server 28 via an instruction module 31 and via a further data line 29. The instruction module is coupled to all of the machines 12, 14, 16.

In other words, the server 28 prepares an analysis into which e.g. operating data of all the machines 12, 14, 16 are entered and on the basis of which the operating state of the paste printer 12 is assessed and changed. In addition, the analysis can be output on a mobile display device 34, e.g. on a tablet computer. The display device 34 is connected to the server 28 by means of a radio connection, wherein the location of the paste printer 12 is also displayed on the display device 34. An employee knows where the respective paste printer 12 is located on the basis of the displayed location and can—after he has arrived at the paste printer 23—additionally monitor the change of the paste order by the paste printer 12 on the basis of the display of the analysis on the mobile display device 34.

The production result of the production line 10 can thus advantageously be improved by the monitoring of a plurality of machines 12, 14, 16 and by the linking of the abstraction data generated in this manner. The data of a plurality of parallel production lines (not shown) can preferably also be evaluated in order to improve the respective production result. The manual effort for quality evaluations, troubleshooting and machine maintenance is reduced. Costs such as for the integration of new systems are reduced and downtimes are minimized.

### LIST OF REFERENCE NUMERALS

10 production line
12 paste printer
14 assembler
16 soldering system
18 components
20 conveyor belt
22 first optical sensor
24 second optical sensor
26 third optical sensor
28 server
29 data line
30a, 30b, 30c abstraction module
31 instruction module
32 central memory device
34 mobile display device

1. A method for the utilization of data from a plurality of machines, the method comprising the steps of:
detecting operating data from a plurality of machines by means of a plurality of sensors, wherein the operating data have different first data formats, with the respective first data format depending on the respective sensor;
converting the operating data by at least one abstraction module into abstraction data, wherein the abstraction data have a uniform second data format and are stored in a central memory device;
carrying out an analysis of the abstraction data, wherein the analysis is based on operating data from at least two machines;
assessing an operating state of one of the machines with reference to the analysis; and
outputting the analysis of the abstraction data.

2. The method in accordance with claim 1,
wherein the analysis is used to control at least one of the machines.

3. The method in accordance with claim 1,
wherein the analysis is used in order to achieve an optimization of he operation of at least one of the machines.

4. The method in accordance with claim 1,
wherein the machines are involved in a common production process.

5. The method in accordance with claim 1,
wherein the first data format is a data format that is used natively by the respective sensor.

6. The method in accordance with claim 1,
wherein the second data format comprises semantics that provides the abstraction data with meanings and associates said abstraction data with at least one category.

7. The method in accordance with claim 6,
wherein the abstraction module automatically provides the operating data with the semantics.

8. The method in accordance with claim 6,
wherein the second data format comprises relationships between the categories of said abstraction data.

9. The method in accordance with claim 1, further comprising the step of:
outputting the analysis on a portable display device that displays a position of the machine to which the analysis is related.

10. The method in accordance with claim 1,
wherein at least one of the abstraction modules is integrated in the respective sensor.

11. The method in accordance with claim 1, further comprising the step of:
outputting the analysis to a production control system and/or to an operation control system.

12. The method in accordance with claim 1,
wherein the analysis comprises a prediction about a future operating state of one of the machines.

13. The method in accordance with claim 1, further comprising the steps of:
detecting operating data from a paste printer and from a soldering system by means of optical sensors;
wherein the analysis comprises the quality of a paste print and the quality of a soldering process; and
carrying out a change in the operation of the soldering system on the basis of the quality of the paste print; and/or
carrying out a change in the operation of the paste printer on the basis of the quality of the soldering process.

14. A system comprising at least two machines, at least two sensors, and a processing device,
wherein the system is configured to carry out a method for the utilization of data from a plurality of machines, the method comprising the steps of:
detecting operating data from the at least two machines by means of the at least two sensors, wherein the operating data have different first data formats, with the respective first data format depending on the respective sensor;
converting the operating data by at least one abstraction module into abstraction data, wherein the abstraction data have a uniform second data format and are stored in a central memory device;
carrying out an analysis of the abstraction data, wherein the analysis is based on operating data from the at least two machines;
assessing an operating state of one of the machines with reference to the analysis; and
outputting the analysis of the abstraction data.

15. The system in accordance with claim 14,
wherein at least one of the sensors is integrated into one of the machines.

16. The system in accordance with claim 14,
wherein at least one of the sensors is a component of one of the machines.
